(19) United States
(12) Patent Application Publication
(10) Pub. No.: US 2006/0158614 A1
(43) Pub. Date: Jul. 20, 2006

(54) Volumetric display

(75) Inventor: Jesse B. Eichenlaub, Penfield, NY (US)

Correspondence Address: Stephen B. Salai, Esq.;Harter, Secrest & Emery LLP, 1600 Bausch & Lomb Place, Rochester, NY, 14604-2711, US

(73) Assignee: Dimension Technologies, Inc., Rochester, NY (US)

(21) Appl. No.: 11/037,614

(22) Filed: Jan. 18, 2005

(51) Int. Cl. G03B 21/00

(52) U.S. Cl. 353/7

(57) ABSTRACT

A three-dimensional volumetric display includes an image generator for generating a three-dimensional image of a first size, a projection lens, and a double fly's eye lense in which the lenslets of a rear sheet have a shorter focal length than the lenses of a front sheet, the front sheet being the sheet closest to the projection lens.

### BACKGROUND OF THE INVENTION

This invention relates generally to the projection of three-dimensional volumetric displays.

### BRIEF SUMMARY OF THE INVENTION

Briefly stated and in accordance with one aspect of the invention, a three-dimensional volumetric display includes a generator for generating a three-dimensional volumetric image, a projection lens for projecting and magnifying the volumetric image, a double fly's eye lens, in which the focal length of the lenslets comprising a front fly's eye lens sheet is shorter than the focal length of the lenslets forming the rear fly's eye lense sheet.

### BRIEF DESCRIPTION OF THE SEVERAL VIEWS OF THE DRAWINGS

FIG. 1 is a diagrammatic view of apparatus for projecting a 3D volume with conventional optics

FIG. 2 is a diagrammatic view of a double fly's eye lens in accordance with this invention.

FIG. 3 is a diagrammatic view of apparatus for projecting a 3-d volumetric image in accordance with this invention.

FIG. 4a is a diagrammatic view of another embodiment of a double fly's eye lens in accordance with this invention.

FIG. 4b is a diagrammatic view of yet another embodiment of a double fly's eye lens in accordance with this invention.

FIG. 5 is a graphical representation of a first order rate tracing and image map graph in accordance with this invention.

FIG. 6 is a diagrammatic view of a volumetric display engine.

FIG. 7a is a diagrammatic view of four volumetric displays in accordance with this invention arranged in an array.

FIG. 7b is a diagrammatic view of embodiment of this invention in which for projectors project an image on a single continuous screen.

FIG. 8 is a diagrammatic view of embodiment of this invention using a two-step magnification process.

FIG. 9 is a diagrammatic view of another embodiment of this invention using a two-step magnification process in which the first stage uses conventional optics.

FIG. 10 is a diagrammatic view of embodiment of this invention that does not require a projection lens.

FIG. 11 is a diagrammatic view of embodiment of this invention for projecting a multi-perspective image.

### DETAILED DESCRIPTION OF THE INVENTION

I have devised a volumetric concept that uses a very small volumetric display and projects the miniature 3D volume to an arbitrary size limited only by the dimensions of the projection screen. In the context of this disclosure, “volumetric” can refer to any space-filling image, whether created by scanning a volume by a surface that displays 2D cross sectional images in succession, or by holography, or by the focusing of light by lenses, or by the presence of a physical object that occupies a volume. For purposes of explanation and illustration the creation, projection and magnification of the first type of volumetric image will be discussed, followed by a discussion of the creation, projection, and magnification of a holographic image. The use of a miniature volumetric display significantly reduces the physical volume of the image forming display device and its mechanical configuration yet can produce a large 40″+ image that can occupy space ranging from several feet in front of the screen to a limitless depth behind the screen. Images can be made to hang in space where collaborators can interact directly with them. The technique can make use of the same imaging engines as those used in the two commercial volumetric displays discussed above. The key innovation in this concept is the ability to magnify and project the 3D volume to an area large enough to accommodate multiple viewers where each viewer has the ability to move freely and observe the smooth parallax and the normal focus and fixation cues associated with viewing real objects.

Projecting a 3D Volume

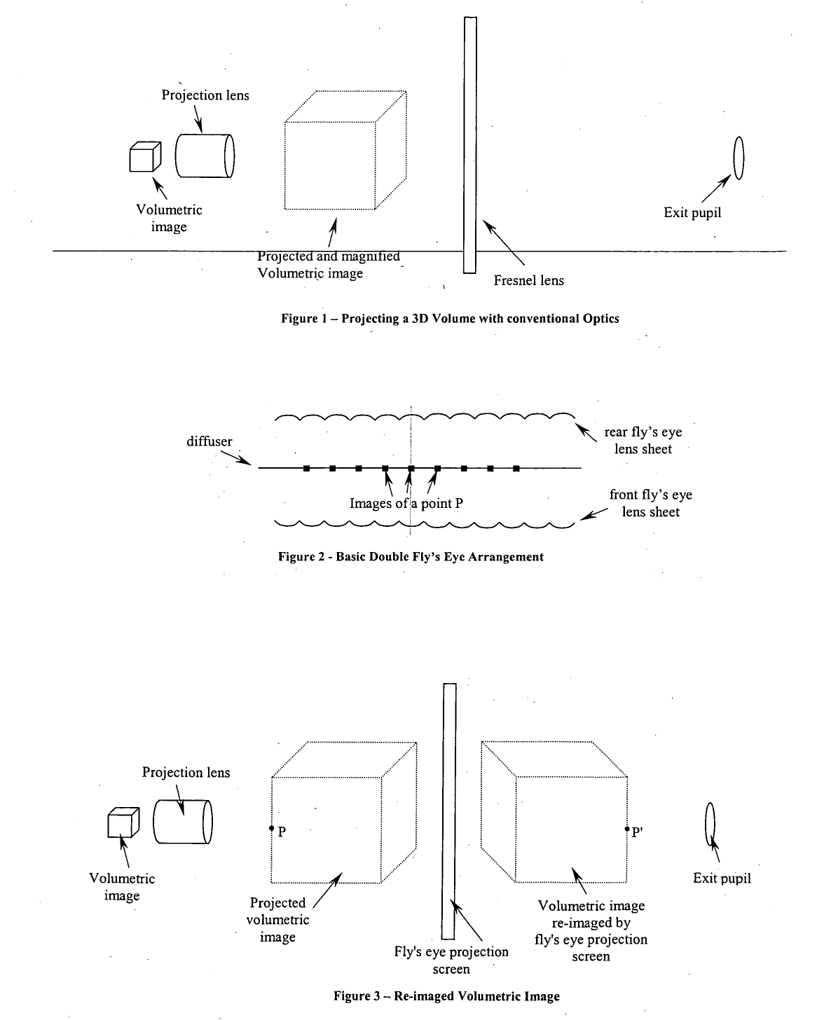

With a 2D image, one can use simply use a projection lens to focus the 2D image onto a diffuse screen and let the screen scatter the light into as large a viewing area as one wants. Use of a simple diffuse screen with a volumetric image is not possible, since different parts of the image are focused at different planes, only one of which can be coincident with the screen. Using conventional optics, there is no practical way, to magnify and project a small volumetric 3D image in such a way that it can be seen across a wide viewing area. The reason for this has to do with basic etendue considerations, and is illustrated in FIG. 1. One could start with a small volumetric image and project it through a typical projection lens into a large space in front of the lens as shown. Different parts of the image would be focused into different points in the larger space. In order to see the image, light would have to be collected by a large lens (such as the Fresnel lens shown) and directed into a viewing area. Unfortunately, such a lens would focus all the light into an image of the projection lens, which forms the exit pupil of the system. The lens would appear to be filled with light and the entire image would be visible only within or very close to this exit pupil.

Since a projection lens for a small image on the order of 25 mm wide would also be small (on the order of 25-50 mm diameter), the lens' image would occupy a small area of about the same size, meaning that in practical terms there would be only enough room for an observer to place one eye within the exit pupil and see the whole image.

The only way to make the exit pupil larger is to focus it farther back from the large lens. Unfortunately, in order to get a decent sized exit pupil and viewing area, the spot has to be focused very far back—on the order of 7 meters, in order to get even a moderately sized (50 cm wide) single person viewing area. However, that would cause the Fresnel lens and the image to appear small and distant making projection with conventional optics impractical.

I have devised an innovative projection screen that effectively diffuses light in a controlled fashion. It does so in such a way that the volumetric image can be re-imaged at a greater size and in such a way that it is visible across a much wider, close in area. The key is the use of a double fly's eye lens in combination with a very fine-grained diffuser.

Double Fly's Eye Lens

A basic double fly's eye lens arrangement is illustrated in FIG. 2. A fly's eye lens typically consists of thousands of small (a few mm down to sub mm wide) spherical or aspheric lenses close packed in an array across a wide flat substrate, as shown. They are made by molding plastic or epoxy with a precision metal tool in which the negative lens pattern has been etched or drilled out. Variations on this basic concept are also possible. For example, the lenses could be tiny diffractive elements instead of curved refractive lenses. They could also be holographic lenses. However, the refractive kind is the most widely used and tends to form the best images.

The double fly's eye lens referred to consists of two such lens sheets aligned and mounted back to back, with their focal planes coincident on a certain plane between them. In the design under consideration, a thin diffuser is placed at this plane. In FIG. 2, the simplest case is shown in which two sets of identical lenses with equal focal lengths are present, and each lens sheet is one focal length away from a diffuser located halfway between them.

A double lens sheet made in this manner has some interesting optical properties that are similar, in some ways, to a large single conventional lens, but with key differences. One similar property is the ability to form images of objects. Light entering the lens array from any point on one side of it is imaged into a collection of thin ray bundles that exit each fly's eye lens and which all intersect at a corresponding point on the other side of the lens sheet, forming small spots of light about the same size as an individual fly's eye lens. This process is illustrated in FIG. 3. Light from any point P is focused into thousands of tiny images by the first set of fly's eye lenses, one image for each fly's eye lens. The spacing of these tiny images is slightly greater than the pitch of the lenses, since the light enters each lens (except the central one) at an angle and therefore the image points (except the center one) are all displaced from the lens centers. This is illustrated in FIG. 2. The lenses on the second sheet, on the other side of the diffuser being likewise displaced from the image point, focus their light into a ray bundles that exit at different angles for each lens and all converge at a single spot. In this particular example, that spot is directly opposite the original point at the same distance from the screen, except on the other side (P′). Thus the images on one side of this double fly's eye lens sheet are mirror images of what is on the other side.

So far, the situation is similar to that encountered with a normal lens—the light from the projection lens is focused into an exit pupil of equally small size on the other side of the lens. The only difference is that the volumetric image is now also re-imaged on the other side of the lens. At this point the double fly's eye lens design offers much greater flexibility in terms of where the re-imaged volumetric image is formed, how large the image can be, and how large the exit pupil can be.

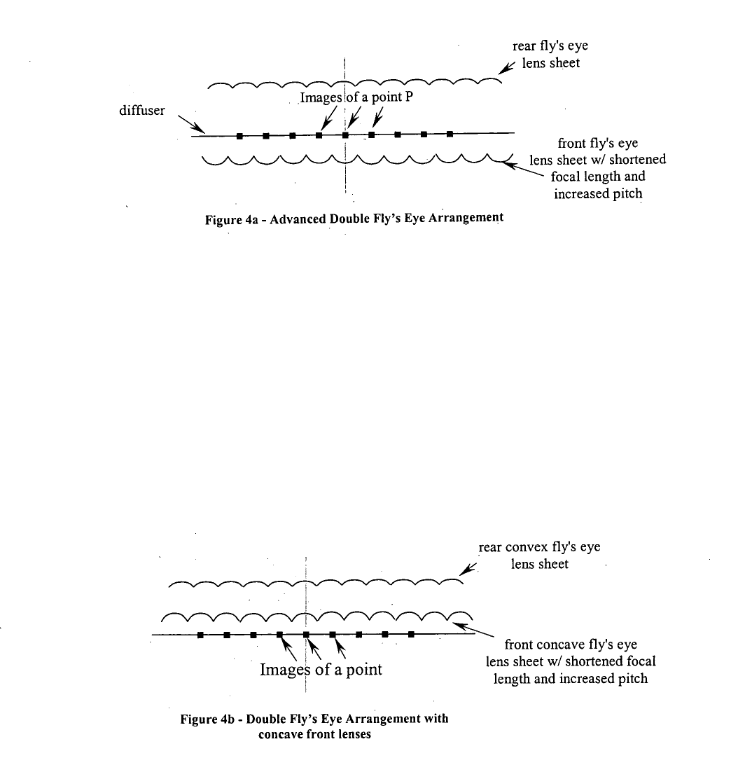

By giving the front fly's eye lenses (the lenses facing the observer) shorter focal lengths and also adjusting their pitch (center to center distance), it is possible to greatly magnify the exit pupil without significantly affecting the volumetric image in the space in front of it. This new fly's eye lens arrangement is illustrated in FIG. 4a. Here, the focal length of the front lenses has been shortened to 1/N their former value. As a result the cone of light exiting the projection lens image on the diffuser becomes much wider—as a matter of fact it is N times wider by the time it reaches the viewing plane where the exit pupil is to be focused. If the size of this exit pupil was formerly 50 mm (about 2″) at this plane, and N is equal to 10 (an entirely reasonable factor) it is now 500 mm (about 20″). However, in order to get all the cones and exit pupils from each fly's eye lens coincident on one another at this plane, the pitch of the front lenses must be increased slightly so that the line between the center of each image and the center of the fly's eye lens goes to the center of the viewing plane. To accomplish this the pitch of the front fly's eye lens sheet must be equal to [D₂/D₁][(D₁+T₁/n)/(D₂+T₂/n)] times the pitch of the rear lenses, where D₁ is the distance between the projection lens and the rear lenses, T₁ is the thickness of the rear lens sheet (which is also the focal length), D₂ is the distance between the front lenses and the viewing plane, T₂ is the thickness of the front lens sheet (again equal to the focal length), and n is the index of the material from which the lens sheets are made. With this relationship between the two fly's eye lens sheets, an image of the projection lens is formed at the viewing plane, in this case 10 times larger that the lens itself. All the exit pupils (images of the projection lens) formed by all the front lenses are coincident. In this example, a viewing plane of 500 mm (20″) is created—large enough for a single person's head to occupy it and move around.

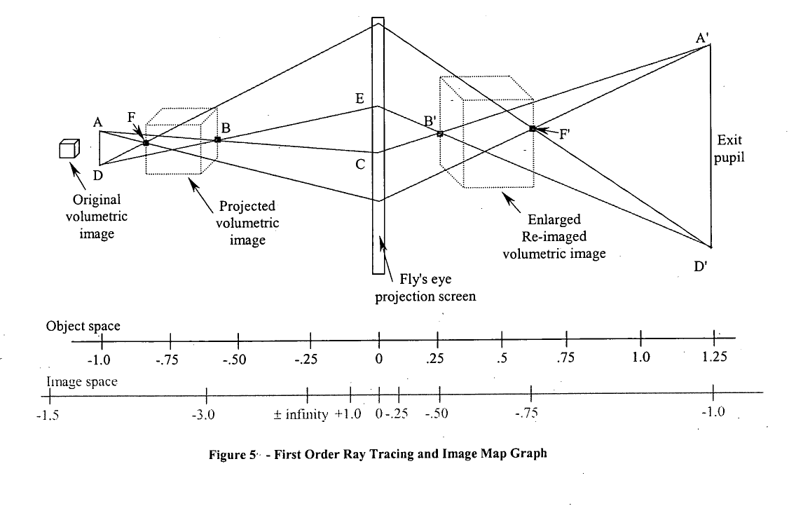

With this configuration the volumetric image will be imaged into the volume between the fly's eye lens sheet and the exit pupil, with some slight compression of its depth. This compression can be allowed for with the rendering of the original volumetric image. It is easy to graphically represent where the projected image will wind up using first order ray tracing, similar to that performed for conventional lenses. This is illustrated in FIG. 5a.

To calculate the position at which point B is imaged, one draws a line between a point A on one edge of the projection lens, through point B, and to point Con the lens sheet. This ray of light will be directed toward the corresponding point A′ at the edge of the image of the projection lens as shown. Likewise one can draw a line from the opposite edge D of the projection lens through point B to point E. This light will be directed to the edge of the image of the projection lens, at point D′ The point where these two lines cross, B′ is the location of the image of point B. All the other rays from point B also intersect at B′. Likewise, a point Fat the other end of the projected image would be imaged at point F′. An image originally focused between the projection lens and the fly's eye lens will be re-imaged between the fly's eye lens and the viewing area in such a way that it's lateral dimensions are increased. The resultant image is much larger than the original and can be seen within a comfortably wide area.

The first order general formula for the position of any image I′ of a point I anywhere on either side of the lens sheets is given by: I′=Y/[(E/P)(X/I−1)+1] or equivalently I′=Y/[{IE/P}{(X−1)/I}+1], where I′ is the distance between the screen and the image, I is the distance between the screen and the object, E is the diameter of the exit pupil, P is the diameter of the projection lens, Y is the distance between the screen and the exit pupil, and X is the distance between the screen and the projection lens. In this formula and in FIG. 5a, the lens sheet thickness is considered to be of zero thickness.

Another useful formula that relates the object and image positions I and I′ directly to the pitch and focal lengths of the lenslets is −P₁I/(I−T₁/n₁)=P₂I/′(I′−T₂/n₂), where P₁ and P₂ are the pitches of the rear and front lenslets, respectively, T₁ and T₂ are the focal lengths (thicknesses) of the rear and front lens sheets, and n1 and n₂ are the indices of refraction of the rear and front lens sheet materials. I is considered positive in front of the lens screen and negative behind it.

A complete map of object positions (the magnified image projected by the lens) vs. image positions is plotted along the bottom of FIG. 5a, with the object positions on the top black line and the corresponding image positions on the bottom green line. An object at the Z position listed on the top line is imaged to the Z position noted below it on the bottom line. Note that the image does not have to occupy the space between the lens sheet and the observer. If the projection lens is used to focus the first image to distances beyond the double fly's eye lens sheet, the double fly's eye lens sheet will then focus the image into the area behind the lens sheet. Thus an image could be represented in a volume occupying an area extending from infinity behind the screen to just in front of the viewing area in front of it.

By changing the relative focal lengths and pitches of the two sheets relative to one another, it is theoretically possible to adjust the size of the exit pupil to any value and place it at any position, except positions that are at or very close to the lens sheets. For example, as the pitch of the front lens sheet in FIG. 4a is increased, the position of the image of the projection lens will move away from the lens sheets, until it is imaged at infinity when the pitch of the front lens sheet is equal to the pitch of the images of point P. By further increasing the pitch of the front lens sheet in FIG. 4a so that it becomes slightly larger than the pitch of the images of point P, one can form an image of the projection lens behind the fly's eye lens sheets (thus forming a virtual exit pupil). By shortening the focal lengths of the lenslets and the frontmost lens sheet, and keeping the lenslets at one focal length from the images of point P, one can increase the size of the image of the projection lens. By increasing the focal length of the lenslets, one can decrease the size of the image of the projection lens. Limits are imposed to magnification only by the quality of the small lenses and the tendency of the lenses to distort images if their focal ratios become too short or if the images are too far off axis.

It is also possible to use a fly's eye lens sheet with concave lenses in place of one of the convex lenses shown in FIGS. 2 and 4a. Such an arrangement is shown in FIG. 4b, where a sheet with concave lenses has been used as the front lens array in the lens screen. In this type of design, the convex rear lenses must focus their images into a plane in front of the front concave lenses at a plane that is close to one focal length from the those lenses. The concave lenses will then collimate the light from the rear convex lenses. The lens screen will operate in the same general manner as the double convex lens screen, but with key differences.

One difference is that a diffuser cannot be used at the focal plane because the focal plane is in front of the front lens sheet. This limits the field of view that can be attained with this design, and limits the formation of side exit pupils next to the main exit pupil.

Another difference is that final images formed in front of the lens screen will be inverted in the X and Y directions. Thus the image of the projection lens will be inverted when it is formed in front of the lens. This fact can be used in first order ray tracing to illustrate other differences in the imaging properties of such a lens screen, as shown in FIG. 5b. One other difference is that images formed by the lens array are no longer inverted in the Z (depth) direction relative to the original image, as shown in FIG. 5b. If a point B is to the left of point F in the diagram, the image of B, called B′, will be to the left of the image of F, called F′. As a result, it is possible to re-image and view real objects without their images inverting in the Z direction.

The formulas used for lens screens with one convex and one concave lenslet sheet are essentially the same as those used for lens screens with two sets of convex lenses: P₁I/{I−[T₂+(T₁−T₂)/n]}=P₂I′/(I′+T₂/n₂), where P₁ and P₂ are the pitches of the rear and front lenslets, respectively, T₁ and T₂ are the focal lengths of the rear and front lens sheets (note that in this case the focal lengths are not equal to the thicknesses of the lens sheets), I and I′ are the Z coordinates of the object and its image, and n₁ and n₂ are the indices of refraction of the rear and front lens sheet materials. I is considered positive in front of the lens screen and negative behind it. The fact that T₁ is partially in air and partially inside the lens material (usually plastic), while T₂ is in air, is what is responsible for the greater complexity of the left side of the equation.

From the formula and the diagram several general aspects of the relationship between object and image positions can be determined. All objects behind the projection lens out to negative infinity are re-imaged in the area between the exit pupil and the lens screen. Furthermore all objects in front of the lens screen out to positive infinity are re-imaged into a much smaller volume directly in front of the lens screen. All objects behind the lens screen and between itself and a certain plane in front of the projection lens are imaged behind the screen, out to minus infinity. All objects between that plane and the projection lens are imaged into the space extending from positive infinity to the exit pupil.

Of interest is the plane marked “S.C.” in the Figure. This is a self-conjugate plane; points in this plane are imaged onto themselves (as virtual images behind the lens screen). Its position on the Z axis is defined by the point where lines from A to A′ and D to D′ cross. All lines from this point to the centers of lenslets in the rear lens sheet will pass through the centers of the lenslets in the front lens sheet. This is actually how the self conjugate plane position is defined: This plane intersects the Z axis at the point where all the lines going through the centers of the rear lenslets and the centers of the corresponding front lenslets intersect each other and the Z axis. Such a plane was also present in the double convex lens sheet design illustrated in FIG. 5, but was not shown because it is far to the left behind the projection lens.

As with the double convex lens sheet case, it is theoretically possible to place the exit pupil practically anywhere and magnify it by any amount by changing the relative pitch and focal lengths of the lenslets. Doing so will effect the relative sizes and positions of the images. The description above and the diagram in FIG. 5 were just one representative case used for illustration purposed.

It is also possible to place the concave lenses on the rear lens sheet and convex lenses on the front lens sheet, but this configuration will not normally be useful since the focal point of the rear concave lenses will always be behind the lenses, thus forcing the focal length of the convex lenses to be longer than those of the convex lenses. As a result such a system will tend to de-magnify, not magnify, pupils and images.

Other Benefits

An important facet of this projection system is its ability to retain the focus and convergence correspondence of the original image. For any point on the image the observer has to focus their eyes and point their eyes at the same spot. This occurs for the same reason as it does in nature because each point on the image is a small blur circle formed at the apex of a cone of converging ray bundles from hundreds of fly's eye lenslets. This matched focus and fixation allows the volumetric images to be viewed without the eyestrain and headaches associated with many synthetic stereoscopic systems.

Another feature of this system is its tendency to generate multiple exit pupils, each of which can be a viewing area, provided that the diffuser between the fly's eye lenses is strong enough. Referring again to FIG. 4, if light from each of the labeled point images behind each fly's eye lens is scattered across a wide enough angle, some of the light from each will enter the fly's eye lenses adjacent to the one behind each point. These adjacent lenses will image additional exit pupils (viewing areas) to the left, right, top, bottom, and diagonally from the main one. Thus, observers inside the adjacent exit pupils will see the volumetric image with some slight distortion sheared toward their position relative to the primary exit pupils' viewing area.

Fly's Eye Projection Screen

Fly's eye lens sheets are made through a master mold and replication process. The tooling to make fly's eye lenses is notoriously expensive, but the lens sheets themselves can be replicated very inexpensively using standard plastic injection molding or pressure molding processes. One advantage that the double fly's eye lens system has is that it is extremely tolerant of lens position errors. Theoretically, it would be possible to use a totally random lens placement pattern as long as the exact same pattern was present on both sheets and the lenses were lined up with one another. Another advantage is that the lens sizes must, of necessity be rather large as fly's eye lenses go (in order to avoid blurring the image)—on the order of 1 mm to a few mm. Lenses in this size range are easier to make than small lenses and are large enough that random variations in curvature and random surface defects occurring during the molding process become insignificant compared to the lens dimensions themselves. Yet the lenses are not large enough that surface curvature errors can creep in during the fabrication process that are large enough to significantly degrade imaging performance.

Making very large sheets of fly's eye lenses will pose some challenge in that to-date, a source of very large sheets has not been found. Fly's eye lens sheets in the 8″×10″ size are readily available. At least one manufacture can produce molds up to 24″ diagonal. For larger sizes, standard lens tiling techniques can be employed either at the replicated lens sheet level or at the mold level.

One method to produce large area fly's eye lenses is to use two sets of lenticular lenses crossed at 90 degrees to achieve the same optical effect as a sheet of fly's eye lenses. Large lenticular lens sheets with lenses of 1 mm width or more, and dimensions of up to over 1 m×1 m in size can be purchased off the shelf. Although these are known to be more than sufficient for this application, it would require four lenses per screen. The most cost effective method for producing large area fly's eye lens sheets will be investigated during Phase I.

Creating a Multiplanar Volumetric Image

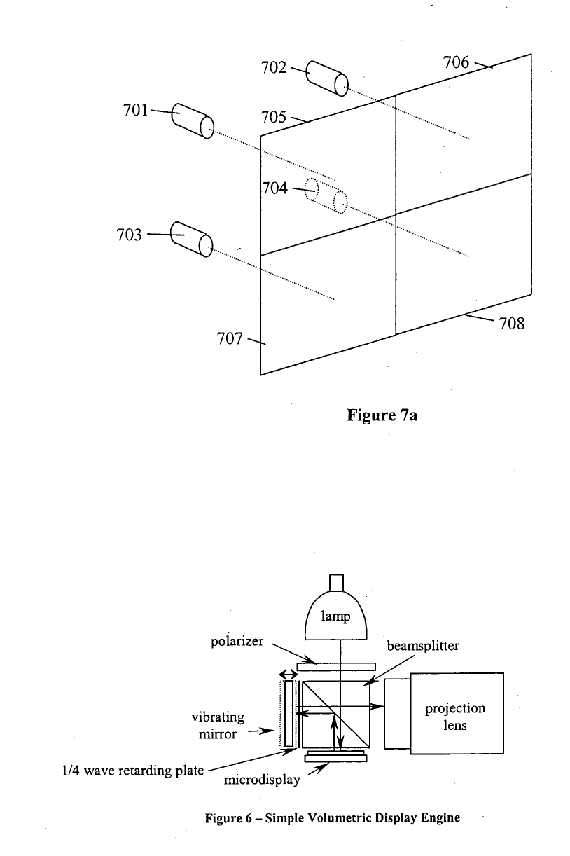

With slight variations, either of the two imaging engines used in the volumetric products mentioned above could in theory be used with this projection technique resulting in presumably a less complicated configuration. One specific example of how the miniature volumetric device can be created is illustrated in FIG. 6. This is not the only way that it can be done, but demonstrates a simple method using off the shelf equipment. A fast miniature (typically <20 mm diagonal) ferroelectric LCD and a vibrating flat mirror are mounted on adjacent sides of a polarizing beam splitting cube as shown. The mirror is situated behind a ¼ wave retarding plate. The LCD is illuminated from the opposite side by a conventional projection lamp. A polarizer placed between the lamp and cube transmits light that travels straight through the mirror in the cube. Some of the pixels in the LCD turn the polarization direction of this light to the orthogonal direction to create bright parts of the image. Light reflecting off the microdisplay that is polarized in this orthogonal direction is reflected toward the mirror by the beamsplitter. The unused light goes back towards the lamp. Upon reflecting from the mirror and passing through the retarder twice, the polarization direction of this light is again turned to the orthogonal direction, causing it to pass through the beamsplitter mirror and on out through the projection lens. Thus, the projection lens views the images of the microdisplay in the mirror.

The mirror is made to vibrate back and forth across a distance of no more than 5-10 mm, which causes the image seen through it to travel back and forth by twice that amount. The mirror can be made to travel back and forth at a 30 cycle rate. In order to maximize the number of planes being represented, the timing of the LCD can be adjusted so that the images formed during the outward leg of the vibration cycle are situated between the images formed on the inward leg of the cycle, instead of being superimposed. These image slices are projected by means of a typical 50 mm projection lens into a series of large flat images within a the space behind the double lens screen.

A variation in this simple scheme that would allow more imaging planes to be projected would use an active (liquid crystal) retarder plate in front of the beamsplitter to cause light from the microdisplay to bounce off of two different mirrors moving out of phase in opposite directions. This would cause the reflection of the microdisplay to seem to repeatedly scan from forward to back (or vice versa) in one direction as light was switched between the two mirrors. This scheme effectively reduces the demands on the microdisplay and can conceivable produce twice as many imaging planes resulting in a larger volume with smooth features.

### SUMMARY

The key innovation in the volumetric concept of this invention is the ability to magnify and project a very small 3D volume in such a manner that the 3D volume can be viewed from a wide area with continuous parallax change and coincident focus and fixation points, features that make volumetric displays highly desirable. The key enabler to this invention's volumetric projection technique is a unique projection screen comprised of a custom configured dual lens sheet that magnifies the original image to a much larger size and re-images the 3D volume. This innovation affords the opportunity not only for much larger volumetric images than currently available, but also for images that can hang in space allowing for direct interaction by observers, and does so in a manner that significantly reduces the complexity and associated cost of directly creating large volumetric images.

Variations on the Concept

In the variations described below, examples with certain arrangements of optics and positions of components and images are described. It is to be understood that these are simply specific examples used for illustrative purposes, and that wide variations from these specific designs are possible which embody the same concepts and features. In particular, variations using both the “double convex lens sheet” and the “convex lens sheet plus concave lens sheet” variety of lens screen are possible, as are variations which place objects, images, entrance pupils and exit pupils in various positions relative to each other and the lens screen.

Tiling

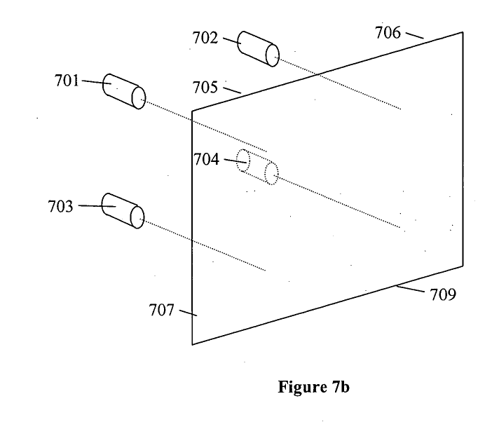

It is possible to tile several volumetric displays of this type together by abutting their lens screens in an M×N array, ideally with enough precision that seams are invisible, as shown in FIG. 7a. In FIG. 7a, projectors 701-704 are positioned behind lens screens 705-708, and the lens screens are abutted together in a 2×2 array. It is also possible to use a single, large continuous screen 709 and place several projectors behind it in an M×N array, as shown in FIG. 7b, ideally with the areas of the screen covered by each matched adequately in brightness, contrast, object positions, etc. to avoid seam visibility or visibly different image characteristics on different parts of the screen.

In either case, the exit pupils of the separate projectors should all be coincident with one another, for example, the width of the exit pupils can be equal to the projector separation (defined her as the projector lens center to lens center distance) in the horizontal direction and the height of the exit pupils can be equal to the projector separation (defined her as the projector lens center to lens center distance) in the vertical direction. In this situation, the exit pupils to the sides of and above and below one projector should be made coincident with the central exit pupils of the projectors to the sides of and above and below it.

A Two Step Magnification Process

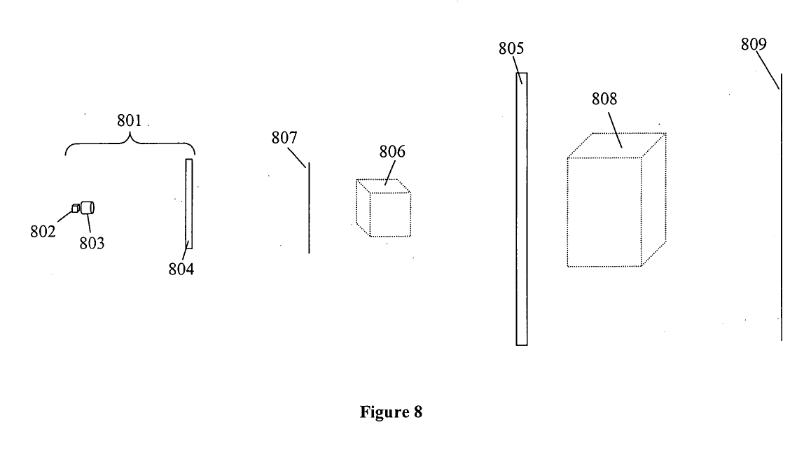

It is also possible to place two or more volumetric projection systems in sequence in order to create very large projected images with very large viewing areas. One variation of such a system is illustrated in FIG. 8. In FIG. 8, one complete volumetric projection system, 801, containing an image forming device 802, such as the vibrating mirror in front of a microdisplay, plus an optional projection lens 803 and a double fly's eye lens screen 804 is placed behind a second, much larger fly's eye lens screen 805 as shown. The volumetric image forming device and the first fly's eye lens screen is used to create a large volumetric image 806 and is also configured to create an exit pupil (the image of the projection lens) 807 in front of itself as shown. This exit pupil becomes the entrance pupil for the second fly's eye lens screen. The second fly's eye lens screen magnifies the volumetric image even further to form image 808 and furthermore the exit pupil is re-imaged in front of the second fly's eye lens sheet, forming a much larger exit pupil and viewing area 809.

Note that if convex fly's eye lenses are used in both lens sheets, then the image reversal along the Z axis produced by the first lens sheet will be reversed back to the original orientation by the second lens sheet.

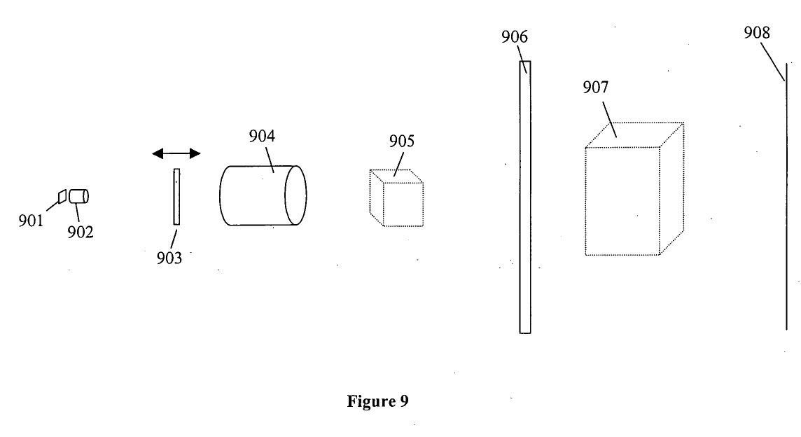

Another possibility is to use a conventional magnification and projection system as the first step. An example is shown in FIG. 9. Here, the image from a stationary fast microdisplay 901 is first projected by projection lens 902 onto a larger diffuser 903. For example, a 1″ diagonal microdisplay image could be projected onto a 4″ diagonal diffuser. This diffuser is placed behind a large projection lens 904, for example the type that is used in some older CRT based projection TVs. Some lenses of that type have a diameter of about 6″. The diffuser or its image is made to vibrate back and forth to create a volumetric image as different image slices are projected onto it. For example, the diffuser itself could vibrate (as illustrated in FIG. 9), a vibrating mirror could be placed in front of the diffuser, or a stack of electronically controlled diffusers could be turned on and off in succession as in the Z 20-20 display made by Vizta3D. The projection lens projects the resulting image into image 905, which is in turn imaged by the second lens screen 906 into image 907. The projection lens is re-imaged into exit pupil 908, which provides a large viewing area.

In either case, the amount of image magnification and the magnification of the size of the exit pupil can be quite large. For example, if the projection lens is 1″ in diameter, and first fly's eye lens screen in FIG. 8 magnifies the projection lens by a factor of ten to form the exit pupil, and the first fly's eye lens screen is 20″ wide, then the second fly's eye lens sheet, could be many times wider than the first, and could easily magnify the exit pupil by another factor of ten. The end result would be a screen several feet on a side visible within a viewing area 100″ wide.

Volumetric Images Without Projection Lenses

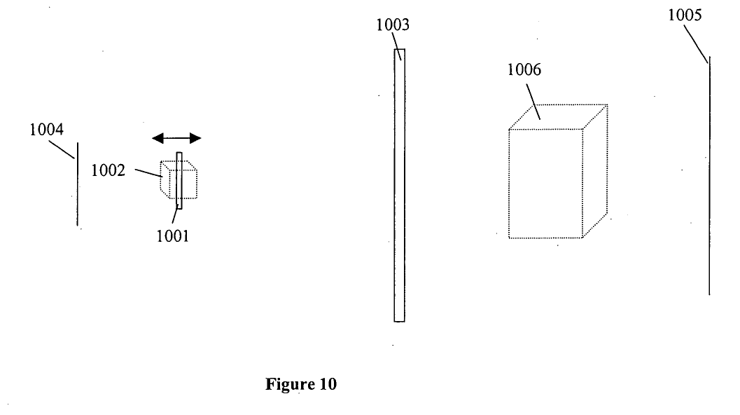

It is not strictly necessary to use a projection lens in the system. For example, by vibrating the microdisplay 1001 in FIG. 10, one could create an image such as the one labeled 1002 in FIG. 10. If the lens screen 1003 were designed to image the imaginary plane 1004 into a second plane 1005 at a comfortable viewing distance from the lens sheet, then the small image 1002 would be imaged into the larger image 1006. Furthermore it would be possible to reposition the image by changing the distance between the original image 1001 and the fly's eye lens screen 1003, either by moving the display and mirror, or moving the fly's eye lens screen.

Projecting Holograms as an Alternative to Multiplanar Volumetric Images

It is possible to magnify and project small photographic or electronic holograms (and even small real objects) in addition to electronically produced volumetric images. This could be done with or without a projection lens, depending on the hologram and its image. In either case the use of the type of magnification and/or projection systems described in this disclosure would allow the use of a very small hologram or electronic display. There is a great advantage to doing this for an electronic display. A display device should be able to produce diffraction patterns on the order of 1 micron in size or less in order to produce good quality, wide angle holograms. The ability to use a small electronic display or displays means that the total resolution necessary for the display could be manageable. For example, a holographic display device of only 4 mm on a side should theoretically be sufficient to produce images whose smallest point-like features can subtend about 1 minute of arc in angular width, based on the diffraction limit for an aperture of that size. Such a display with pixels 1 micron on a side would need a total resolution of 4000×4000 pixels. This total pixel resolution is nearly within the reach of today's display technology for a single display (4000×2000 displays are under development). However, the required pixel size is not. A known method exists, however, to de-magnify images form a larger display to form a much smaller hologram with much higher spatial resolution on its surface.

This method of producing pixels with such small size is to de-magnify and project the image of a high resolution microdisplay (with pixels on the order of 10-15 microns wide) onto a much smaller photosensitive layer (such as an oil film or a liquid crystal layer) whose transmittance, thickness, diffraction index, or some other optical property changes according to how much light is falling on it, thus forming a much smaller image that can be used to form a hologram by means of coherent light reflecting from or shining through the photosensitive layer. This method of making holograms with high spatial resolution from larger display devices with lower spatial resolution is well known to the art. One way of implementing it would be to use the method of increasing the resolution of a microdisplay in a time multiplexed fashion using sub-pixel illumination, as described in Dimension Technologies, Inc. U.S. Pat. No. 6,734,838 B1, herein incorporated as a reference, and projecting the resulting ultra high resolution image onto the photosensitive layer. It is possible, using off the shelf high resolution fast microdisplays, to create images with more than 4000×4000 resolution using Dimension Technologies, Inc.'s sub pixel illumination technique.

In the case of still photographic holograms the advantage to the magnification/projection system described here is in the fact that only a small piece of very high resolution photographic film is needed to make the hologram, vs. a full size piece that is a large as the final image. In addition, the apparatus needed to make the hologram is commensurately smaller. All this adds up to less expense and less effort required to make the hologram.

Projecting Small Autostereoscopic Images

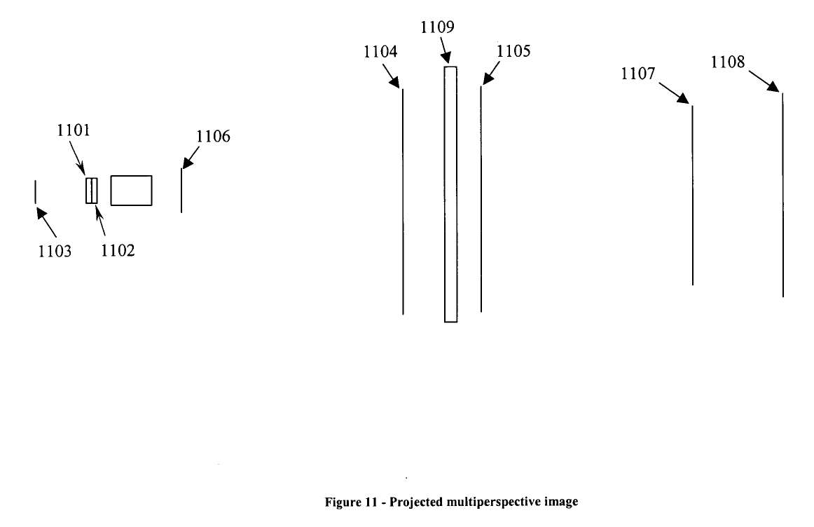

It is also possible to magnify and project small autostereoscopic displays of the multiperspective type, where different perspective views of a scene are visible from within different “viewing zones” spaced across a “viewing zone plane” in front of a display. Such displays are very well known to the art. When used with the type of magnifying and projection arrangement described above, it is possible to create a very small multiperspective display using a microdisplay plus optics or an illumination system that forms rather small viewing zones in a plane close to the display. The images on the display and the viewing zones can then be projected by a projection lens and re-imaged by a double fly's eye lens structure into a large image of the display and a large set of viewing zones in the space in front of the lens sheets. Such an arrangement is illustrated in FIG. 11.

Here, a small, microdisplay 1101 is shown with a lenticular lens sheet 1102 placed in front of it. The lens sheet is designed to create several viewing zones within plane 1103. The use of lenticular lenses placed in front of an electronic display to form viewing zones is described in numerous US patents including U.S. Pat. No. 4,872,750 (Morishita), U.S. Pat. No. 4,957,351 (Shioji), and U.S. Pat. No. 4,959,641 (Bass), herein incorporated as references. There are many other methods of producing autostereoscopic images in which different viewing zones are formed at a certain plane in front of the display. Some of these different methods are described in U.S. Pat. No. 3,878,329 (Brown), U.S. Pat. No. 4,717,949 (Eichenlaub), U.S. Pat. No. 5,132,839 (Travis), U.S. Pat. No. 5,430,474 (Hines), U.S. Pat. No. 5,546,120 (Miller et. al.), and U.S. Pat. No. 6,590,605 (Eichenlaub) herein incorporated as references. Any of these methods could in theory be used with the type of magnification and/or projection system described here. Furthermore many of these methods (like the lenticular lens method described above) can be employed on slower, larger displays, since they do not require the use of time multiplexing to create the multiple perspective views required. Such displays can make use of larger projection lenses, which would be ideal for use with very large lens screens to produce very large exit pupils and viewing areas for large audience viewing. Also, note that in FIG. 11 the viewing zone plane 1103 is located behind the microdisplay. It is possible to create a viewing zone plane at any position along the Z axis relative to the display, from plus infinity to-infinity by appropriately designing the pitch of the lenses (or other structures) relative to the pitch of the pixels on the display. A discussion of this, and how such a viewing zone plane can be re-imaged by lenses, can be found in the paper “Prototype Magnified and Collimated Autostereoscopic Displays” (Proceedings of the SPIE Vol. 2653, pages 20-31), herein incorporated as a reference.

In this example, the lens screen 1109 has two sets of convex lenslets; however as in the other examples a lens screen with one sheet of convex lenslets and another sheet of concave lenslets could be used instead, requiring the sue of different object and image positions.

In the case shown, the front of the projection lens is imaged into plane 1108 by the lens screen 1109. The microdisplay is imaged by the projector lens into the space behind the fly's eye lens at plane 1104. In some circumstance this is superior to projecting it onto the fly's eye lens because moiré patterns are not set up between the lenslets and the pixels of the projected image. In this case, the fly's eye lens screen focuses the image into a plane in front of itself at 1105. However, it is also possible to focus it onto a plane in front of the fly's eye lens screen, in which case the fly's eye lens screen will focus it behind, or to focus it onto the fly's eye lens screen itself, as long as the pitches of the lenses are much smaller and different than the pixel images, so that moiré patterns are not formed.

The viewing zone plane is in turn focused into plane 1106 by the projection lens, and re-imaged into plane 1107 by the fly's eye screen. The individual viewing zones will be imaged into larger viewing zones in plane 1107. A person sitting near plane 1107 will always have on eye in one viewing zone and the other eye in another, and thus each eye will perceive a different perspective view, and the user will perceive an image with depth.

Experimental Verification

A simple bench model of the type of optics described here was built, and its imaging properties measured to verify that it would be able to project and magnify volumetric images in the manner described. The model consisted of a light source, a 25 mm f/0.95 projection lens, a double fly's eye lens sheet consisting of two identical 152 mm×76 mm (6″×3″) off the shelf arrays of 1 mm square lenses, and an additional double convex lens.

In order to cause the two identical lens arrays to have two different focal lengths, the rear lens was immersed in a small transparent container holding water, the index of refraction of which differed by that of the plastic lenses by only about 0.2. This increased the focal length of the lenses greatly compared to what it was in air. The resulting ratio of the focal lengths of the two sets of lenses, and thus the magnification of each lens pair, was 2.35×. Although the pitch of the two lens sheets was identical, the effects associated with varying the pitch of one of them could be achieved by adding a single large positive lens behind the rear lens sheet. This 100 mm diameter lens had a focal length of 225 mm. No volumetric image generating apparatus was present, but the various planes within such an image could be simulated by mounting a 35 mm color slide behind the projection lens so that the distance between it and the projection lens could be varied, thus causing the plane at which the projection lens re-imaged the slide to be positioned anywhere in front of the projection lens from about 50 mm front of it to infinity.

The imaging behavior of the system was consistent with the theory discussed in section 2. When set up for comfortable viewing, the model created an array of 140 mm diameter exit pupils within a plane at about 75 cm from the lens sheets, formed from the 20 mm diameter entrance pupil created by a stop within the projection lens. 2D images on stationary color slides that were projected into the space between the projection lens and the fly's eye lens screen were re-imaged by the lens screen into the space in front of the lens screen. When images were projected toward the space in front of the fly's eye lens screen by moving the slide closer to the projection lens, they were re-imaged by the lens screen into the space behind it. All parts of these images could be seen from anywhere within the central exit pupil, and clearly exhibited parallax relative to the lens screen itself. Furthermore these were clearly optical images, for example, one had to change the focus of a single lens reflex camera in order to focus on the images seen in front of or behind the fly's eye screen when they changed position, and when the images were formed in front of the fly's eye lens sheet, one could focus them onto a piece of ground glass.

To evaluate the concept for creating the small volumetric image a basic vibrating mirror system was configured. The system was constructed using a 1″ square mirror attached to an off the shelf actuator motor controlled by a circuit which allowed adjustment of the vibration speed and amplitude of the motor. The model is integrated with a simple image generator, beamsplitters, and an off the shelf 640×480 LCOS microdisplay capable of presenting 24 buffered images every 1/60th second. This assembly was placed behind a projection lens and the double fly's eye lens screen assembly described above. A simple three-dimensional wire frame image was successfully demonstrated by displaying 24 slices in succession as the mirror vibrated through a range of +/−0 mm to about +/−3 mm. When projected by the fly's eye projection screen the resulting image occupied a volume ranging from 0 to many inches deep. Its position can be adjusted between the front and rear of the lens screen by adjusting the position of the projection lens.

While the invention has been described in connection with several presently preferred embodiments thereof, those skilled in the art will recognize that many modifications and changes may be made therein without departing from the true spirit and scope of the invention which accordingly is intended to be defined solely by the appended claims.

1. A volumetric 3D display comprising:
a three-dimensional volumetric image generator generating a 3D image of a first size;
a projection lens; and
a double fly's eye lens, in which the lenses of a rear sheet have a shorter focal length than the lenses of a front sheet (closest to the projection lens).

2. The display of claim 1 in which the three-dimensional volumetric image generator is an electronic holographic generator.
